(19) United States
(12) Patent Application Publication
(10) Pub. No.: US 2025/0383521 A1
(43) Pub. Date: Dec. 18, 2025

(54) CAMERA MODULE

(71) Applicant: SAMSUNG ELECTRO-MECHANICS CO., LTD., Suwon-si (KR)

(72) Inventors: Yun Gu LEE, Suwon-si (KR); Po Chul KIM, Suwon-si (KR); Ta Kyoung LEE, Suwon-si (KR)

(73) Assignee: SAMSUNG ELECTRO-MECHANICS CO., LTD., Suwon-si (KR)

(21) Appl. No.: 18/923,842

(22) Filed: Oct. 23, 2024

(30) Foreign Application Priority Data
Jun. 13, 2024 (KR) 10-2024-0076818

(51) Int. Cl. G02B 7/02; G03B 17/17; G03B 30/00

(52) U.S. Cl. CPC G02B 7/02; G03B 17/17; G03B 30/00

(57) ABSTRACT

A camera module is provided. The camera module includes a housing which has an internal space; a lens module accommodated in the internal space, and at least a portion of the lens module is configured to move in an optical axis direction; and a first stopper and a second stopper spaced apart in the optical axis direction in the housing, and each includes a buffer member that protrudes toward the lens module; a plurality of dampers that are spaced apart in the optical axis direction and protrude toward the first stopper and the second stopper, are provided on at least one side of the lens module, and the plurality of dampers and the buffer member are disposed opposite to each other in the optical axis direction.

### CROSS-REFERENCE TO RELATED APPLICATIONS

This application claims the benefit under 35 USC § 119(a) of Korean Patent Application No. 10-2024-0076818 filed on Jun. 13, 2024, in the Korean Intellectual Property Office, the entire disclosure of which is incorporated herein by reference for all purposes.

### BACKGROUND

### 1. Field

The following description relates to a camera module that is implemented in a mobile device.

### 2. Description of Related Art

Camera modules are implemented in mobile devices such as, but not limited to, smartphones, tablet personal computers (PCs), and laptops. Additionally, camera modules implemented in mobile devices may typically have autofocusing (AF) and optical imaging stabilization (OIS) operations, and there is a trend of adding zoom operations.

Whether the camera module operates normally when an external impact occurs is one of the important factors determining the quality of the camera module. However, the higher the performance of the camera module, the heavier the weight of the components, which is a disadvantage in terms of impact vulnerability.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a camera module includes a housing which has an internal space; a lens module accommodated in the internal space, and at least a portion of the lens module is configured to move in an optical axis direction; and a first stopper and a second stopper spaced apart in the optical axis direction in the housing, and each of the first stopper and the second stopper comprises a buffer member that protrudes toward the lens module; wherein a plurality of dampers, that are spaced apart in the optical axis direction and protrude toward the first stopper and the second stopper, are provided on at least one side of the lens module, and wherein the plurality of dampers and the buffer member are disposed opposite to each other in the optical axis direction.

The buffer member and the plurality of dampers may be formed of an elastic material.

The lens module may include a lens barrel including at least one lens, and fixedly disposed in the housing; and a lens holder including at least one lens, and configured to move in the optical axis direction in the housing; wherein the plurality of dampers are provided on the lens holder.

The lens holder may include a lens mounting portion that is spaced apart from the lens barrel in the optical axis direction, and on which the at least one lens is mounted; and a first support portion and a second support portion that extend in the optical axis direction from a first side of the lens mounting portion and a second side of the lens mounting portion toward the lens barrel, respectively; wherein the plurality of dampers are provided on at least one of the first support portion and the second support portion.

The plurality of dampers may be formed integrally with the lens holder.

The camera module may further include a damper holder coupled to at least one side surface of the lens holder, wherein the plurality of dampers are provided on the lens holder via the damper holder.

The plurality of dampers may include a pair of dampers that are disposed in a direction perpendicular to the optical axis direction, and the buffer member may include a pair of protrusions that face the pair of dampers in the optical axis direction.

The lens module may include a lens module driving portion including a driving magnet and a driving coil, and configured to provide a driving force to move the lens holder in the optical axis direction, wherein the driving magnet is disposed on a first side surface of the lens holder, and wherein the plurality of dampers may be disposed on a second side surface of the lens holder opposite to the first side surface of the lens holder at least with respect to an optical axis.

The camera module may further include a folded module including a reflective member, and the folded module is disposed in front of the lens module based on a path of light; an image sensor module including an image sensor, and disposed at a rear portion of the lens module based on the path of light; wherein the first stopper and the second stopper may be disposed between the folded module and the lens module, and may be further disposed between the lens module and the image sensor module.

In a general aspect, a camera module includes a folded module disposed in a housing, and configured to change a path of light; a lens module comprising one or more lenses on which light passing through the folded module is incident; an image sensor module into which light passing through the lens module is incident; and a first stopper and a second stopper spaced apart in an optical axis direction with the lens module interposed therebetween; wherein a buffer member is provided on the first stopper and the second stopper, respectively, to protrude toward the lens module, and a plurality of dampers are provided on the lens module, to protrude toward the first stopper and the second stopper respectively, and face the buffer member in the optical axis direction.

The lens module may include a lens barrel fixedly disposed in the housing; and a lens holder disposed in the housing, and configured to move in the optical axis direction between the folded module and the image sensor module, wherein the plurality of dampers may be provided on the lens holder.

The plurality of dampers may be formed integrally with the lens holder.

The plurality of dampers may be spaced apart from each other in the optical axis direction on at least one side surface of the lens holder.

The camera module may further include a damper holder coupled to at least one side surface of the lens holder; wherein the plurality of dampers are provided on the lens holder via the damper holder.

The plurality of dampers may include a pair of dampers that are disposed in a direction perpendicular to the optical axis direction, wherein the buffer member may include a pair of protrusions that face the pair of dampers in the optical axis direction.

The buffer member and the plurality of dampers may be formed of an elastic material.

In a general aspect, a camera module includes a housing comprising an internal space; a lens holder disposed in the internal space and configured to move in an optical axis direction; and a first stopper disposed in the housing, and the first stopper comprises a buffer member that protrudes toward the lens module; wherein a damper, that protrudes toward the first stopper, is disposed on at least one side of the lens holder, and wherein the damper and the buffer member are disposed opposite to each other in the optical axis direction.

A second stopper may be spaced apart from the first stopper in the optical axis direction.

Other features and aspects will be apparent from the following detailed description, the drawings, and the claims.

### BRIEF DESCRIPTION OF DRAWINGS

FIG. 1 illustrates a perspective view of an example camera module, in accordance with one or more embodiments.

FIG. 2 illustrates a perspective view of an example camera module with the cover omitted in FIG. 1.

FIG. 3 illustrates a top view of the example camera module illustrated in FIG. 2.

FIG. 4 illustrates a partial cross-sectional view of I-I′ of FIG. 2.

FIG. 5 illustrates a schematic exploded perspective view of an example camera module, in accordance with one or more embodiments.

FIG. 6 illustrates an exploded perspective view of an example folded module, in accordance with one or more embodiments.

FIG. 7 illustrates a top view of an example folded module, in accordance with one or more embodiments.

FIG. 8 illustrates a bottom view of an example folded module, in accordance with one or more embodiments.

FIG. 9 illustrates an exploded perspective view of an example lens module, in accordance with one or more embodiments.

FIG. 10 illustrates a side view of an example lens holder, in accordance with one or more embodiments.

FIG. 11 illustrates an exploded perspective view of an example lens holder and a stopper, in accordance with a first example embodiment.

FIG. 12A and FIG. 12B are side views illustrating a state in which a lens holder, in accordance with the first example embodiment, is in contact with a stopper while being moved to the maximum.

FIG. 13A illustrates an exploded perspective view of a lens holder (including a damper holder) and a stopper, in accordance with a second example embodiment.

FIG. 13B illustrates a perspective view of an example lens holder, in accordance with the second example embodiment.

FIG. 14 illustrates an exploded perspective view of an example lens holder and a stopper, in accordance with a third example embodiment.

FIG. 15 illustrates an exploded perspective view of an example lens holder and a stopper, in accordance with a fourth example embodiment.

FIG. 16A and FIG. 16B are side views illustrating the lens holder according to the fourth example embodiment in a state where it is in contact with the stopper while being moved to the maximum.

FIG. 17 illustrates an exploded perspective view of the example lens holder and stopper according to the fifth example embodiment.

FIG. 18 illustrates an exploded perspective view of the example lens holder and stopper according to a sixth example embodiment.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more examples may improve the reliability of a camera module.

One or more examples may alleviate problems of deformation and/or damage to an injection molded product, and the generation of foreign objects due to collisions between components when an impact is applied to the camera module.

One or more examples may improve the quality of the camera module. Specifically, the one or more examples may reduce noise (sound) generated due to collisions between internal components of the camera module.

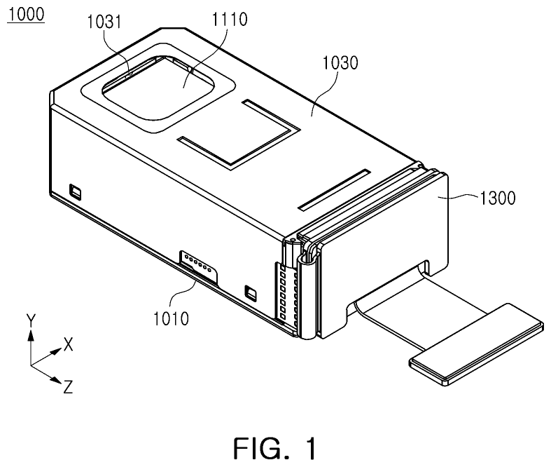

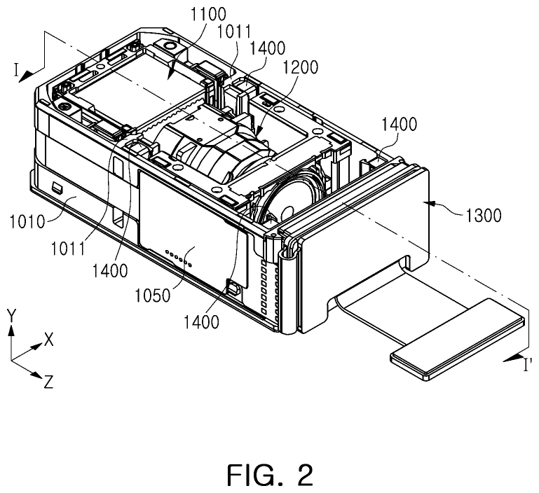

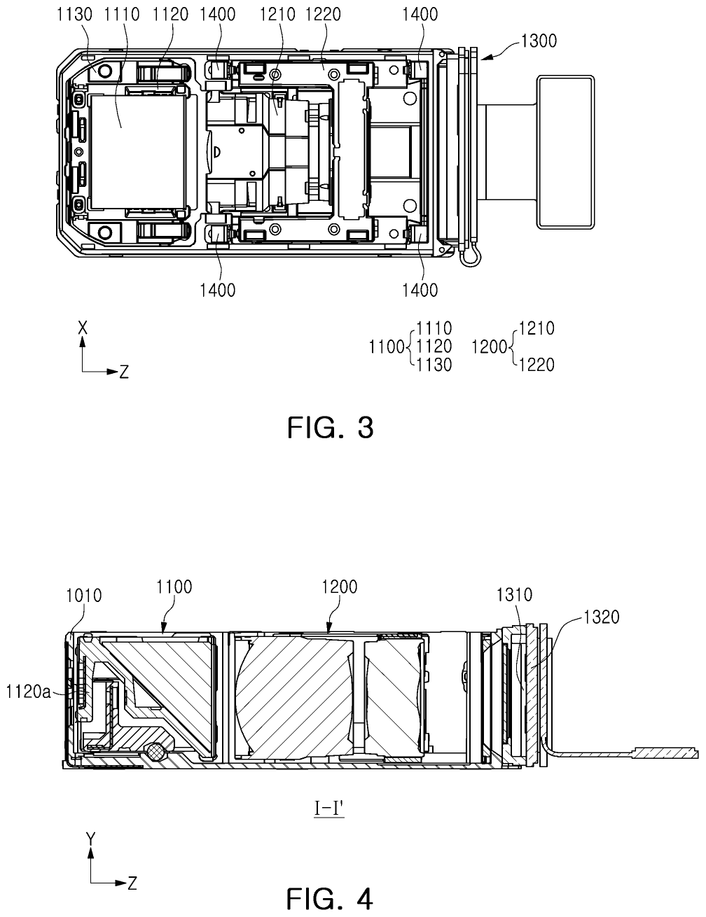

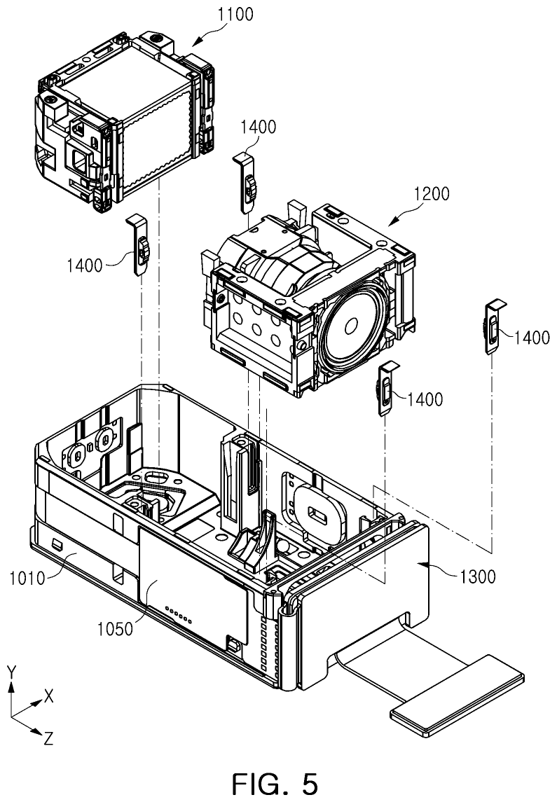

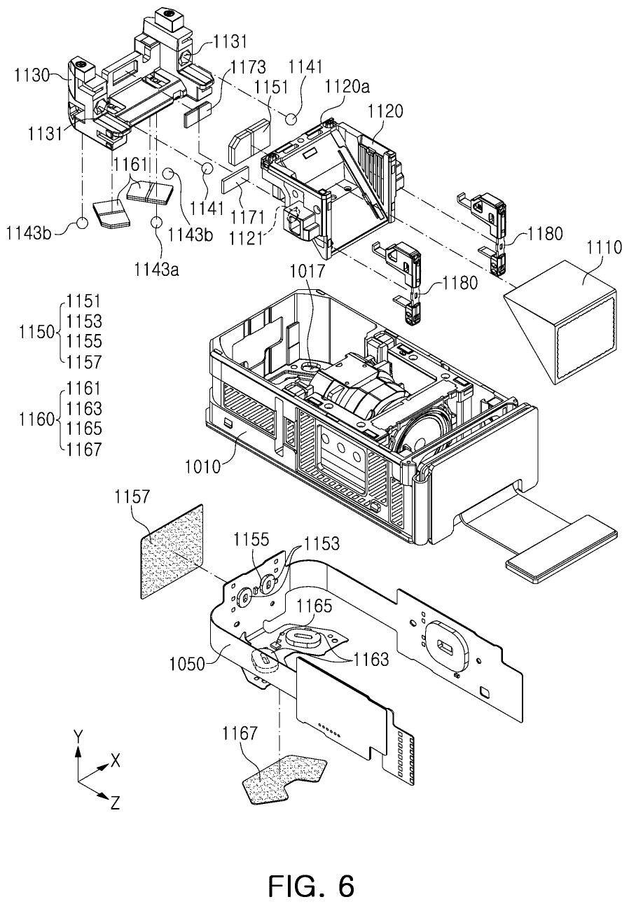

FIG. 1 illustrates a perspective view of an example camera module, in accordance with one or more embodiments, FIG. 2 illustrates a perspective view of an example camera module with the cover omitted in FIG. 1, FIG. 3 illustrates a top view of the example camera module illustrated in FIG. 2, FIG. 4 illustrates a partial cross-sectional view of I-I′ of FIG. 2, and FIG. 5 illustrates a schematic exploded perspective view of an example camera module, in accordance with one or more embodiments.

Referring to FIG. 1, the camera module (1000), in accordance with one or more embodiments, may include a housing (1010) and a cover (1030) coupled to the housing (1010). The housing (1010) and the cover (1030) may constitute the exterior of the camera module (1000).

The cover (1030) may include an opening (1031). Light reflected from an external subject may enter the camera module (1000) through the opening (1031).

The cover (1030) may be formed of a material including a metal material to operate as a shield can.

Referring to FIGS. 2 to 5, the camera module (1000), in accordance with one or more embodiments, may include a folded module (1100), a lens module (1200), and an image sensor module (1300). In a non-limited example, each of these modules may be provided in the housing (1010).

The folded module (1100) may be configured to change a direction of light. Light incident into the camera module (1000) through the opening (1031) of the cover (1030) may have its direction of travel changed in a direction from the folded module (1100) to the lens module (1200). For example, light incident in a thickness direction (first optical axis direction) (Y-axis direction) of the camera module (1000) may have its direction of travel changed to a direction approximately parallel to a length direction (second optical axis direction) (Z-axis direction) of the camera module (1000) based on the folded module (1100).

The camera module (1000), in accordance with one or more embodiments, may provide a relatively large total track length (TTL) without significantly increasing the thickness of the camera module (1000) by having a folded module (1100). The total track length may be defined as the maximum distance between the lens surface closest to an object side among a plurality of lenses provided in the lens module (1200) to be described later and an imaging plane of an image sensor to be described later, and the longer the total track length, the more advantageous it may be for implementing a high zoom ratio.

The lens module (1200) may be configured to refract light. Light reflected from the folded module (1100) may be refracted while passing through the lens module (1200).

An image sensor module (1300) may include an image sensor (1310) and a printed circuit board (sensor board) (1320) on which the image sensor (1310) is mounted.

The image sensor (1310) may be disposed so that its imaging plane faces the lens module (1200), and may generate an electric signal corresponding to light passing through the lens module (1200) and is incident on the imaging plane. The electric signal converted by the image sensor (1310) may be displayed as a visual image on a screen (display) of a mobile device.

The image sensor module (1300) may further include an optical filter that filters light passing through the lens module (1200) and is incident on the image sensor (1310). In an example, the optical filter may be an infrared cut filter (IR cut filter) that blocks light in an infrared region among the light passing through the lens module (1200) and is incident on the image sensor (1310).

The housing (1010) may have an internal space. The internal space of the housing (1010) may accommodate the folded module (1100) and the lens module (1200). The housing (1010) may include a protrusion wall (1011) that extends between the internal space where the folded module (1100) may be accommodated and the internal space where the lens module (1200) may be accommodated from both side walls.

The image sensor module (1300) may be coupled to the housing (1010) from the outside of the housing (1010).

The folded module (1100), the lens module (1200), and the image sensor module (1300) may be sequentially disposed along the second optical axis direction (Z-axis direction). Therefore, in an example, the housing (1010) may have a length in the second optical axis direction (Z-axis direction). However, in another example, the folded module (1100), the lens module (1200), and the image sensor module (1300) may be accommodated in different housings. In this example, a housing in which the folded module (1100) is accommodated, a housing in which the lens module (1200) is accommodated, and a housing in which the image sensor module (1300) is accommodated may be disposed in the second optical axis direction (Z-axis direction).

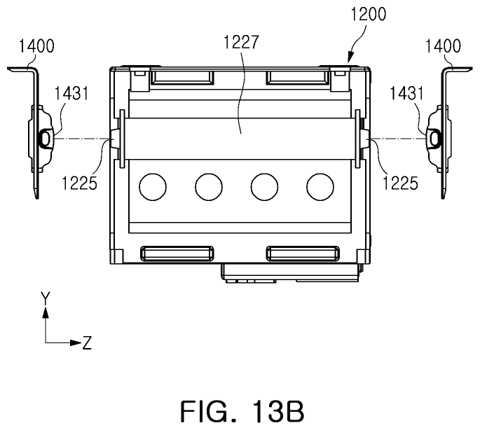

Additionally, a stopper (1400) may be disposed in the housing (1010). The stopper (1400) may be coupled to the protruding wall (1011) and a coupling groove (1013) (FIG. 13) formed in a portion facing the protruding wall (1011) in the second optical axis direction (Z-axis direction).

In an example, the stopper (1400) may be provided in multiple pieces. A portion of a plurality stoppers (1400)—the first stopper—may be coupled to the coupling groove (1013) that is formed in the protruding wall (1011), and may be disposed between the folded module (1100) and the lens module (1200). Additionally, a portion of the remaining stoppers (1400)—the second stopper—may be coupled to the coupling groove (1013) formed in a portion that faces the protruding wall (1011) of the housing (1010) in the second optical axis direction (Z-axis direction) and may be disposed between the lens module (1200) and the image sensor module (1300). That is, the first stopper and the second stopper may be disposed spaced apart in the second optical axis direction (Z-axis direction).

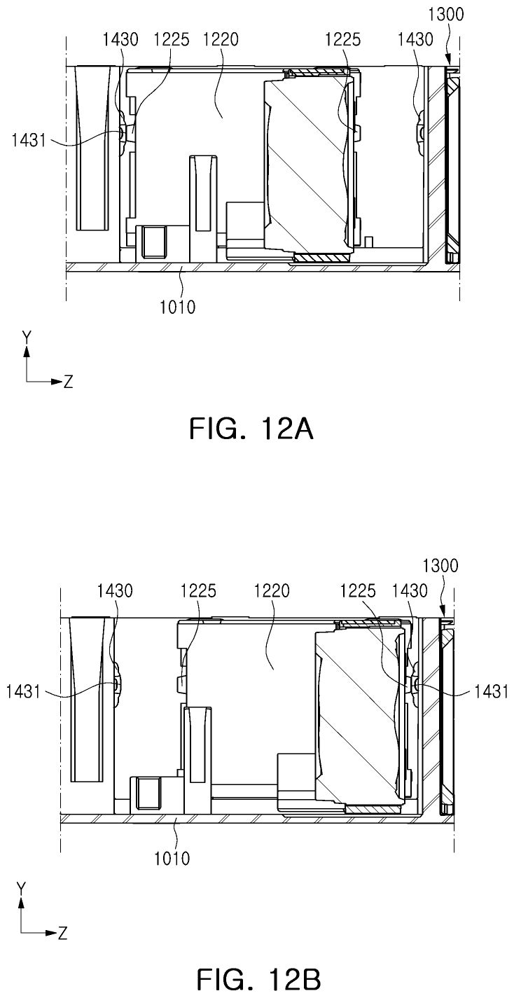

Referring to FIG. 11, the stopper (1400) may include a frame (1410) that is coupled to the coupling groove (1013), and a buffer member (1430) that is disposed on the frame (1410), and protrudes toward the lens module (1200).

The frame (1410) may be formed of a rigid material to support the buffer member (1430), and the buffer member (1430) may be formed of an elastic material such as thermoplastic polyurethane (TPU), rubber, silicone, etc., as only examples. However, the material of the buffer member (1430) may not limited to those listed above, and may be formed of other materials with similar properties.

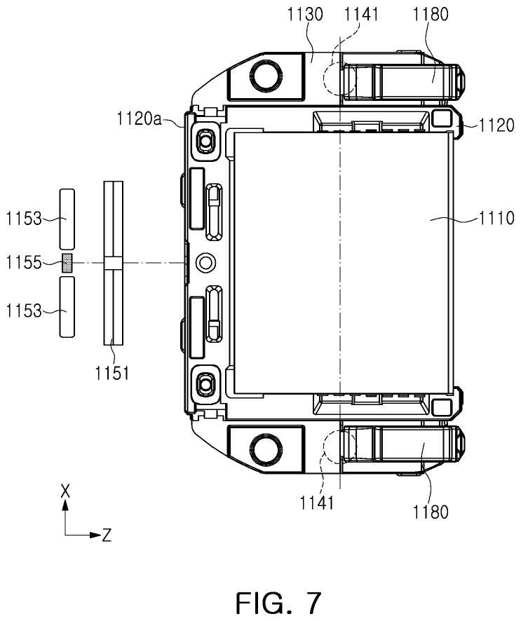

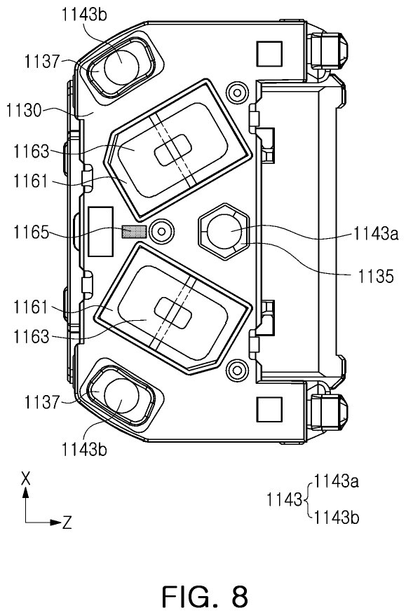

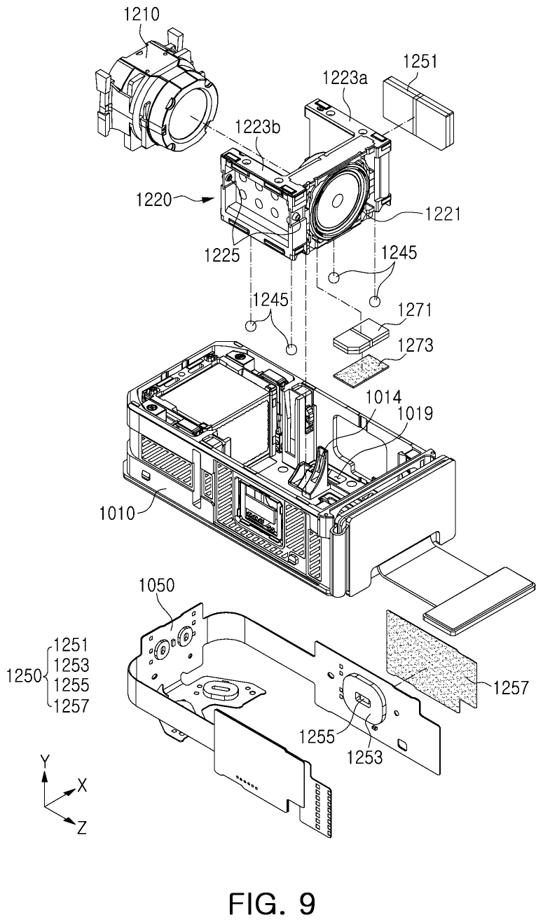

FIG. 6 is an exploded perspective view of a folded module, in accordance with one or more embodiments, FIG. 7 is a top view of a folded module, in accordance with one or more embodiments, and FIG. 8 is a bottom view of a folded module, in accordance with one or more embodiments.

The folded module (1100) may be rotatably provided in the housing (1010). In an embodiment, the folded module (1100) may be rotated about two rotation axes perpendicular to the second optical axis (Z-axis). The folded module (1100) may be rotated about the first rotation axis (first axis) (X-axis) and the second rotation axis (second axis) (Y-axis). The first rotation axis (X-axis) and the second rotation axis (Y-axis) may both be perpendicular to the second optical axis (Z-axis) and may be perpendicular to each other. The camera module (1000), in accordance with one or more embodiments may implement a shake correction operation based on the rotation of the folded module (1100).

Referring to FIG. 6, the folded module (1100) may include a reflective member (1110), a reflective holder (1120), and a rotation holder (1130).

The reflective member (1110) may change a direction of light incident on the inside of the camera module (1000) by about 90 degrees. In a non-limited example, the reflective member (1110) may be provided as a mirror or prism.

The reflective member (1110) may be mounted on the reflective holder (1120).

Additionally, the reflective holder (1120) may be rotatably supported on the rotation holder (1130) while the reflective member (1110) is mounted thereon.

A first ball group (1141) may be disposed between the reflective holder (1120) and the rotation holder (1130), and the reflective holder (1120) may be rotatably supported on the rotation holder (1130) by the first ball group (1141). The first ball group (1141) may include a plurality of ball members that are spaced apart in the first axis direction (X-axis direction).

The reflective holder (1120) and the rotation holder (1130) may include receiving grooves (1121, 1131) which may be spaced apart from each other in the first axis direction (X-axis direction) on the surfaces facing each other, and may receive a portion of a plurality of ball members included in the first ball group (1141). The receiving grooves (1121, 1131) may be provided in a number corresponding to the plurality of ball members included in the first ball group (1141).

In an embodiment, the reflective holder (1120) may be provided with a first receiving groove (1121), and the rotation holder (1130) may be provided with a second receiving groove (1131). The first receiving groove (1121) and the second receiving groove (1131) may face each other in the second optical axis direction (Z-axis direction).

The plurality of ball members included in the first ball group (1141) may be fitted between the first receiving groove (1121) and the second receiving groove (1131). The first receiving groove (1121) and the second receiving groove (1131) may be formed to have two or more inclined surfaces, and a portion of the grooves may be formed to have at least three inclined surfaces. The plurality of ball members included in the first ball group (1141) may be supported on at least two-points by the first receiving groove (1121) and the second receiving groove (1131), and a portion may be supported on at least three-points. Therefore, the first ball group (1141) may form the first rotation axis (X-axis) of the reflective holder (1120) while rotating in place while being fitted between the first receiving groove (1121) and the second receiving groove (1131). The reflective holder (1120) may be rotated relative to the rotation holder (1130) with respect to the first rotation axis (X-axis) formed by the first ball group (1141).

To prevent a detachment of the first ball group (1141), the reflective holder (1120) may closely contact the rotation holder (1130) in the second optical axis direction (Z-axis direction) in which the first receiving groove (1121) and the second receiving groove (1131) face each other.

In an embodiment, a first magnetic member (1171) may be disposed in the reflective holder (1120), and a second magnetic member (1173) may be disposed in the rotation holder (1130) so as to face the first magnetic member (1171) in the second optical axis direction (Z-axis direction).

The first magnetic member (1171) and the second magnetic member (1173) may generate a magnetic attraction between each other. One of the first magnetic member (1171) and the second magnetic member (1173) may be a pulling magnet, and the other may be a pulling yoke or a pulling magnet. For example, the first magnetic member (1171) may be a pulling yoke that is fitted into a reflective holder (1120), and the second magnetic member (1173) may be a pulling magnet that is disposed in the rotation holder (1130).

The magnetic attraction may act in the second optical axis direction (Z-axis direction) in which the first magnetic member (1171) and the second magnetic member (1173) face each other, and accordingly, the reflective holder (1120) may be in close contact with the rotation holder (1130) in the second optical axis direction (Z-axis direction).

The rotation holder (1130) may be coupled with an auxiliary member (1180) to surround both sides of the reflective holder (1120). The auxiliary member (1180) may be coupled to the rotation holder (1130) at a distance from the reflective holder (1120) so as not to interfere with the rotation of the reflective holder (1120).

The auxiliary member (1180) may prevent the reflective holder (1120) from being separated from the rotation holder (1130). Additionally, the damper provided in the auxiliary member (1180) may prevent direct collision between the reflective holder (1120) and the rotation holder (1130) due to the rotation of the reflective holder (1120).

The rotation holder (1130) may be rotatably supported on the housing (1010).

A second ball group (1143) may be disposed between the rotation holder (1130) and the housing (1010), and the rotation holder (1130) may be rotatably supported on the housing (1010) by the second ball group (1143). The second ball group (1143) may include one rotation axis ball (1143a) and a plurality of guide balls (1143b) spaced apart from the rotation axis ball (1143a).

The rotation holder (1130) and the housing (1010) may include a receiving groove for receiving a portion of the rotating shaft ball (1143a) and a guide groove (1137, 1017) for receiving a portion of the plurality of guide balls (1143b) on surfaces facing each other. The guide grooves (1137, 1017) may be provided in a number corresponding to the plurality of guide balls (1143b).

In an embodiment, the rotation holder (1130) may be provided with a third receiving groove (1135) (FIG. 8), and the housing (1010) may be provided with a fourth receiving groove (not shown). The third receiving groove (1135) and the fourth receiving groove may face each other in the first optical axis direction (Y-axis direction).

The rotation shaft ball (1143a) may be fitted between the third receiving groove (1135) and the fourth receiving groove. The third receiving groove (1135) and the fourth receiving groove may be formed to have at least three inclined surfaces, and the rotation shaft ball (1143a) may be supported at least at three-points in the third receiving groove (1135) and the fourth receiving groove. Therefore, the rotation shaft ball (1143a) may form the second rotation axis (Y-axis) of the rotation holder (1130) while rotating in place while being fitted between the third receiving groove (1135) and the fourth receiving groove. The rotation holder (1130) may be rotated relative to the housing (1010) based on the second rotation axis (Y-axis) formed by the rotation shaft ball (1143a).

Additionally, in an embodiment, the rotation holder (1130) may be provided with the first guide groove (1137), and the housing (1010) may be provided with a second guide groove (1017). The first guide groove (1137) and the second guide groove (1017) may face each other in the first optical axis direction (Y-axis direction).

The plurality of guide balls (1143b) may be fitted between the first guide groove (1137) and the second guide groove (1017). The first guide groove (1137) and the second guide groove (1017) may be in a form of curves that extend in a direction of a circumference of a circle centered on the second rotation axis (Y-axis). On the other hand, the first guide groove (1137) and the second guide groove (1017) may be in a form of straight lines that extend in a direction of a tangent of the circumference of a circle centered on the second rotation axis (Y-axis). The plurality of guide balls (1143b) may move in a rolling manner along the extension direction of the guide grooves (1137, 1017) while being fitted between the first guide groove (1137) and the second guide groove (1017). That is, the plurality of guide balls (1143b) may maintain a gap between the rotation holder (1130) and the housing (1010), and support the rotation of the rotation holder (1130) about the second rotation axis (Y-axis).

To prevent the detachment of the second ball group (1143), the rotation holder (1130) may closely contact the housing (1010) in the first optical axis direction (Y-axis direction) in which the third receiving groove (1135), the fourth receiving groove, and the first guide groove (1137) and the second guide groove (1017) face each other.

In an embodiment, a third magnetic member (1161) may be disposed in the rotation holder (1130), and a fourth magnetic member (1167) may be disposed in the housing (1010) so as to face the third magnetic member (1161) in the first optical axis direction (Y-axis direction).

The third magnetic member (1161) and the fourth magnetic member (1167) may generate a magnetic attraction between each other. In an embodiment, the third magnetic member (1161) may be a second driving magnet to be described later, and the fourth magnetic member (1167) may be a second yoke to be described later. The magnetic attraction may act in the first optical axis direction (Y-axis direction) in which the third magnetic member (1161) and the fourth magnetic member (1167) face each other, and accordingly, the rotation holder (1130) may be closely contacted to the housing (1010) in the first optical axis direction (Y-axis direction).

The folded module (1100) may include a driving unit that provides a driving force to rotate the reflective holder (1120) and the rotation holder (1130).

The folded module (1100) may include a first driving portion (reflective holder driving portion) (1150) that provides the driving force to rotate the reflective holder (1120) about the first rotation axis (X-axis) relative to the rotation holder (1130).

The first driving portion (1150) may include a first driving magnet (1151) disposed in the reflective holder (1120) and a first driving coil (1153) disposed in the housing (1010). The reflective holder (1120) may include an extension (1120a) that extends between the rotation holder (1130) and the housing (1010), and the first driving magnet (1151) may be disposed in the extension (1120a) so as to face one surface of the housing (1010).

The first driving coil (1153) may be disposed on one surface of the housing (1010) that faces the first driving magnet (1151). The first driving coil (1153) may be disposed in the housing (1010) while being attached to the main board (1050). The housing (1010) may include an opening so that the first driving coil (1153) may be exposed to the internal space.

The first driving coil (1153) may be exposed to the internal space of the housing (1010) through the opening and may face the first driving magnet (1151) directly.

Referring to FIG. 7, the first driving magnet (1151) and the first driving coil (1153) may face each other in the second optical axis direction (Z-axis direction), and the driving force to rotate the reflective holder (1120) may be provided based on the interaction therebetween.

In an embodiment, the first driving magnet (1151) may face two first driving coils (1153), which may provide the driving force to rotate the reflector holder (1120) about the first rotational axis (X-axis).

The first driving portion (1150) may further include a first position sensor (1155) detecting a position (rotation amount) of the reflective holder (1120). As a non-limited example, the first position sensor (1155) may be provided as a Hall sensor.

The first position sensor (1155) may be attached to the main board (1050) together with the first driving coil (1153) and disposed in the housing (1010) so as to face the first driving magnet (1151).

The first position sensor (1155) may be disposed to face the neutral region provided between the N pole and S pole of the first driving magnet (1151) and may detect the position (rotation amount) of the reflective holder (1120) effectively.

Additionally, the first driving unit (1150) may further include a first yoke (1157) disposed to face the first driving magnet (1151) with the first driving coil (1153) and the first position sensor (1155) interposed therebetween.

The first yoke (1157) may be disposed to cover the other surface of the main board (1050) (meaning the opposite surface of the surface on which the first driving coil (1153) and the like may be disposed) from the outside, thereby blocking leakage of the magnetic force generated from the first driving magnet (1151) and concentrating the magnetic force.

The folded module (1100) may include a second driving unit (rotation holder driving portion) (1160) that provides a driving force to rotate the rotation holder (1130) about the second rotation axis (Y-axis) relative to the housing (1010).

The second driving unit (1160) may include the second driving magnet (1161) disposed in the rotating holder (1130) and a second driving coil (1163) disposed in the housing (1010).

The second driving magnet (1161) may be disposed on a bottom surface of the rotation holder (1130) and may be disposed between one rotation axis ball (1143a) and the plurality of guide balls (1143b).

The second driving coil (1163) may be disposed on one surface of the housing (1010) facing the second driving magnet (1161). The housing (1010) may include an opening so that the second driving coil (1163) may be exposed to an internal space. The second driving coil (1163) may be exposed to the internal space of the housing (1010) through the opening and may face the second driving magnet (1161) directly.

Referring to FIG. 8, the second driving magnet (1161) and the second driving coil (1163) may face each other in the first optical axis direction (Y-axis direction), and the driving force to rotate the rotation holder (1130) may be provided by the interposed therebetween.

In an embodiment, the second driving magnet (1161) and the second driving coil (1163) may be provided in one or more corresponding numbers and may face each other one-to-one, and may provide the driving force to rotate the rotation holder (1130) about the second rotation axis (Y-axis).

The second driving portion (1160) may further include a second position sensor (1165) that detects the position (rotation amount) of the rotary holder (1130). In a non-limited example, the second position sensor (1165) may be provided as a Hall sensor.

The second position sensor (1165) may be attached to the main board (1050) together with the second driving coil (1163) and may be disposed in the housing (1010) so as to face the second driving magnet (1161). The second position sensor (1165) may be disposed so as to face the neutral region provided between the N pole and the S pole of the second driving magnet (1161) and may detect the position (rotation amount) of the rotary holder (1130) effectively.

Additionally, the second driving portion (1160) may further include the second yoke (1167) disposed to face the second driving magnet (1161) with the second driving coil (1163) and the second position sensor (1165) interposed therebetween.

The second yoke (1167) may be disposed to cover the other surface of the main board (1050) (meaning the opposite surface of the surface where the second driving coil (1163), etc., may be disposed) from the outside, thereby blocking leakage of a magnetic force generated from the second driving magnet (1161) and concentrating the magnetic force.

Additionally, the second yoke (1167) may generate a magnetic force with the second driving magnet (1161), thereby causing the rotating holder (1130) to be closely contacted the bottom surface of the housing (1010).

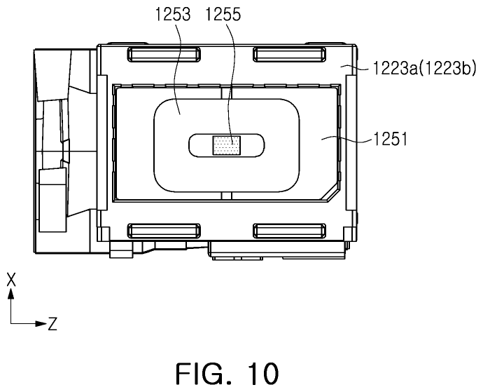

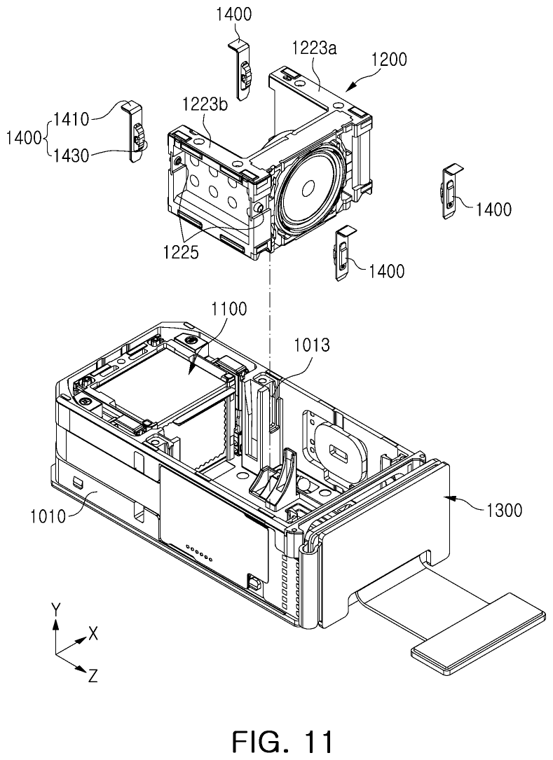

FIG. 9 is an exploded perspective view of an example lens module, in accordance with one or more embodiments, and FIG. 10 is a side view of one side of an example lens module, in accordance with one or more embodiments.

Referring to FIG. 9, the lens module (1200) may include a lens barrel (1210) and a lens holder (1220).

Additionally, the lens module (1200) may include a plurality of lenses disposed along the second optical axis direction (Z-axis direction). The plurality of lenses may refract light emitted from the folded module (1100).

A plurality of lenses may be separately mounted on the lens barrel (1210) and the lens holder (1220). That is, the lens barrel (1210) and the lens holder (1220) may each include at least one lens disposed along the second optical axis direction (Z-axis direction).

In an example, the lens barrel (1210) may be fixedly disposed in the housing (1010). In an embodiment, a portion of the lens barrel (1210) may be coupled to a mounting portion (1014) provided in an internal space of the housing (1010), and the lens barrel (1210) may be spaced apart from the bottom surface of the housing (1010) by a predetermined distance (roughly corresponding to a diameter of a plurality of ball members included in a third ball group (1245) (described later) while coupled to the mounting portion (1014). However, in another embodiment, the lens barrel (1210) may be a movable member and may be provided to be driven independently of the lens holder (1220) described later.

The lens holder (1220) may include a lens mounting portion (1221) on which at least one lens is mounted, and support portions (1223a, 1223b) extending in the second optical axis direction (Z-axis direction) on both sides of the lens mounting portion (1221).

The lens mounting portion (1221) may be disposed between the lens barrel (1210) and the image sensor module (1300). Therefore, light incident on the camera module (1000) may pass through at least one lens mounted on the lens barrel (1210), and may then be incident on at least one lens mounted on the lens holder (1220).

The support portions (1223a, 1223b) may include a first support portion (1223a) and a second support portion (1223b) that extend in the second optical axis direction (Z-axis direction) toward the lens barrel (1210) from a first side and a second side of the lens mounting member (1221), respectively.

That is, the first support portion (1223a) and the second support portion (1223b) may be disposed on opposite sides with respect to the second optical axis (Z axis) to be spaced apart in the width direction (X-axis direction) of the camera module (1000).

Since the lens holder (1220) may have the structure described above, the lens barrel (1210) may be disposed in a space defined at least partially by the lens mounting portion (1221) of the lens holder (1220) and the first support portion (1223a) and the second support portion (1223b).

The lens holder (1220) may be provided movably in the housing (1010). In an embodiment, the lens holder (1220) may be moved forward and backward in the second optical axis direction (Z-axis direction). The camera module (1000), in accordance with one or more embodiments, may implement a focus adjustment operation and a zoom operation by moving the lens module (1200), specifically, the lens holder (1220).

The third ball group (1245) may be disposed between the lens holder (1220) and the housing (1010), and the lens holder (1220) may be movably supported on the housing (1010) by the third ball group (1245).

The third ball group (1245) may include a plurality of ball members disposed between the lens holder (1220) and the housing (1010), and specifically, between the first support portion (1223a) and the housing (1010) and between the second support portion (1223b) and the housing (1010). A plurality of ball members spaced apart in the second optical axis direction (Z-axis direction) may be disposed between the first support portion (1223a) and the housing (1010), and between the second support portion (1223b) and the housing (1010).

The lens holder (1220) and the housing (1010) may include guide grooves that accommodate a portion of a plurality of ball members included in the third ball group (1245) on each of the surfaces that face each other. The guide grooves may be provided in a number corresponding to the plurality of ball members included in the third ball group (1245).

In an embodiment, the lens holder (1220) may be provided with a third guide groove (not shown), and the housing (1010) may be provided with a fourth guide groove (1019). The third guide groove and the fourth guide groove (1019) may face each other in the first optical axis direction (Y-axis direction).

The plurality of ball members included in the third ball group (1245) may be fitted between the third guide groove and the fourth guide groove (1019). The third guide groove and the fourth guide groove (1019) may be disposed in a straight line form that extends approximately in the second optical axis direction (Z-axis direction). The plurality of ball members included in the third ball group (1245) may move in a rolling manner along the extension direction of the guide groove while being fitted between the third guide groove and the fourth guide groove (1019). That is, the third ball group (1245) may maintain a gap between the lens holder (1220) and the housing (1010), and may support a movement of the lens holder (1220) in the second optical axis direction (Z-axis direction).

To prevent the detachment of the third ball group (1245), the lens holder (1200) may be closely contacted to the housing (1010) in the first optical axis direction (Y-axis direction) where the third guide groove and the fourth guide groove (1019) face each other.

In an embodiment, a fifth magnetic member (1271) may be disposed in the lens holder (1220), and a sixth magnetic member (1273) may be disposed in the housing (1010) so as to face the fifth magnetic member (1271) in the first optical axis direction (Y-axis direction).

The fifth magnetic member (1271) and the sixth magnetic member (1273) may generate a magnetic attraction between each other. One of the fifth magnetic member (1271) and the sixth magnetic member (1273) may be a pulling magnet, and the other may be a pulling yoke or a pulling magnet. For example, the fifth magnetic member (1271) may be a pulling magnet disposed in the lens holder (1220), and the sixth magnetic member (1273) may be a pulling yoke inserted in the housing (1010).

The magnetic attraction may act in the first optical axis direction (Y-axis direction) in which the fifth magnetic member (1271) and the sixth magnetic member (1273) face each other, and accordingly, the lens holder (1220) may be closely contacted to the housing (1010) in the first optical axis direction (Y-axis direction).

The lens module (1200) may include a driving portion that provides a driving force to move the lens holder (1220).

The lens module (1200) may include a third driving portion (lens module driving portion) (1250) that provides a driving force to move the lens holder (1220) in the second optical axis direction (Z-axis direction) relative to the housing (1010).

The third driving portion (1250) may include a third driving magnet (1251) disposed in the lens holder (1220) and a third driving coil (1253) disposed in the housing (1010).

The third driving magnet (1251) may be disposed on a side surface of the support portion of the lens holder (1220), for example, the first support portion (1223a) (or the second support portion (1223b)), so as to face a side surface of the housing (1010).

The third driving coil (1253) may be disposed on a side surface of the housing (1010) facing the third driving magnet (1251). The third driving coil (1253) may be disposed in the housing (1010) while being attached to the main board (1050). The housing (1010) may include an opening so that the third driving coil (1253) may be exposed to the internal space. The third driving coil (1253) may be exposed to the internal space of the housing (1010) through the opening so as to directly face the third driving magnet (1251).

Referring to FIG. 10, the third driving magnet (1251) and the third driving coil (1253) may face each other in the direction (X-axis direction) of an axis (third axis) perpendicular to both the first optical axis (Y-axis) and the second optical axis (Z-axis), and the driving force to move the lens holder (1220) may be provided based on the interaction between them.

In an embodiment, the third driving magnet (1251) and the third driving coil (1253) may be provided in one or more corresponding numbers, and may face each other one-to-one, and they can provide a driving force to move the lens holder (1220) in the second optical axis direction (Z-axis direction). As the lens holder (1220) moves in the second optical axis direction (Z-axis direction), the second optical axis direction (Z-axis direction) gap between the lens holder (1220), the image sensor (1310) and the lens barrel (1210) may be changed.

The third driving unit (1250) may further include a third position sensor (1255) that detects the position (movement amount) of the lens holder (1220). As an example, the third position sensor (1255) may be provided as a Hall sensor.

The third position sensor (1255) may be attached to the main board (1050) together with the third drive coil (1253) disposed in the housing (1010) so as to face the third drive magnet (1251). The third position sensor (1255) may be disposed to face the neutral region provided between the N pole and S pole of the third drive magnet (1251) so as to effectively detect the position (movement amount) of the lens holder (1220).

Additionally, the third driving unit (1250) may further include a third yoke (1257) disposed to face the third driving magnet (1251) with the third driving coil (1253) and the third position sensor (1255) interposed therebetween.

The third yoke (1257) may be disposed to cover the other surface of the main board (1050) (meaning the opposite surface of the surface on which the third drive coil (1253), etc., may be disposed) from the outside, thereby blocking leakage of the magnetic force generated from the third drive magnet (1251) and concentrating the magnetic force.

Referring to FIG. 11. in an example, as described above, a plurality of stoppers (1400) may be disposed in the housing (1010). Specifically, the plurality of stoppers (1400) may be disposed in the housing (1010) to face the lens holder (1220) in the direction of movement of the lens holder (1220), i.e., in the second optical axis direction (Z-axis direction), and the plurality of stoppers (1400) may face the first support portion (1223a) or the second support portion (1223b), respectively.

The stopper (1400) may be provided with the buffer member (1430) that may be formed of an elastic material that protrudes toward the lens holder (1220), and may be configured to absorb shock and noise.

Additionally, in accordance with one or more embodiments, the lens holder (1220) may be provided with a damper (1225) that is formed to protrude toward the stopper (1400) so as to face the buffer member (1430) of the stopper (1400) in the second optical axis direction (Z-axis direction). The damper (1225) may be formed of an elastic material, similar to the buffer member (1430).

According to the structure, when the lens holder (1220) moves to the maximum position in the second optical axis direction (Z-axis direction), the damper (1225) of the lens holder (1220) and the buffer member (1430) of the stopper (1400) come into mutual contact. Accordingly, a collision between rigid parts (e.g. injection-molded products) may be prevented.

Additionally, since both the damper (1225) and the buffer member (1430), which contact each other, may be formed of an elastic material, the driving distance of the lens holder (1220) may not be limited, and at the same time, noise generation may be reduced.

Hereinafter, various embodiments of the lens holder (1220) and the stopper (1400) may be described with reference to FIGS. 11 to 18.

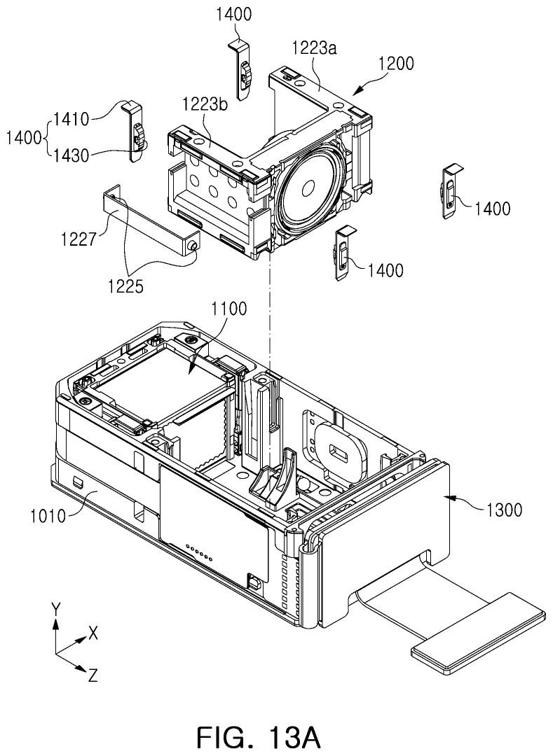

FIG. 11 is an exploded perspective view of a lens holder and a stopper according to the first example embodiment, and FIGS. 12A and 12B are side views illustrating the lens holder according to the first example embodiment in contact with the stopper while being moved to the maximum position.

Referring to FIG. 11, the second support portion (1223b) (or the first support portion (1223a)) of the lens holder (1220) may be provided with a plurality of dampers (1225) that are spaced apart in the second optical axis direction (Z-axis direction). In an example, the plurality of dampers (1225) may be formed integrally with the lens holder (1220) through an insert injection-molded process.

The plurality of dampers (1225) may be formed to protrude toward the stopper (1400) at a position facing the buffer member (1430). Preferably, the plurality of dampers (1225) may be provided to face the maximum protruding surface (meaning the most protruding portion from a surface of the frame (1410)) (or protrusion) (1431) of the buffer member (1430).

That is, the gap formed between the plurality of dampers (1225) and the stopper (1400) in the second optical axis direction (Z-axis direction) may be narrower than the gap formed between the second support portion (1223b) (or the first support portion (1223a)) and the stopper (1400) in the second optical axis direction (Z-axis direction).

Therefore, when the lens holder (1220) is moved to the maximum position along the second optical axis direction toward the folded module (1100) (−Z-axis direction movement) as illustrated in FIG. 12a, and when the lens holder (1220) is moved to the maximum position along the second optical axis direction toward the image sensor module (1300) (movement in the +Z-axis direction) as shown in FIG. 12b, the damper (1225) and the buffer member (1430) may contact with each other, and a contact between the lens holder (1220) and the housing (1010) may be blocked. In an example, the contact between the damper (1225) and the buffer member (1430) may be a surface contact.

FIG. 13A illustrates an exploded perspective view of an example lens holder (including a damper holder) and a stopper according to a second example embodiment, and FIG. 13B illustrates a perspective view of an example lens holder according to a second example embodiment.

Referring to FIG. 13A, a damper holder (1227) may be disposed on the second support portion (1223b) (or the first support portion (1223a)) of the lens holder (1220). In an example, the damper holder (1227) may be extended in the second optical axis direction (Z-axis direction) and may be coupled to a side surface of the second support portion (1223b) (or the first support portion (1223a)) that faces the housing (1010).

The damper holder (1227) may be provided with a plurality of dampers (1225) that are spaced apart in the second optical axis direction (Z-axis direction). In an example, the plurality of dampers (1225) may be formed integrally with the damper holder (1227) through an insert injection-molded process.

A plurality of dampers (1225) may be formed to protrude toward the stopper (1400), and the damper holder (1227) may be coupled to the second support portion (1223b) (or the first support portion (1223a)) so that the plurality of dampers (1225) face the buffer member (1430). Preferably, the plurality of dampers (1225) may face the maximum protrusion surface (or protrusion) (1431) of the buffer member (1430).

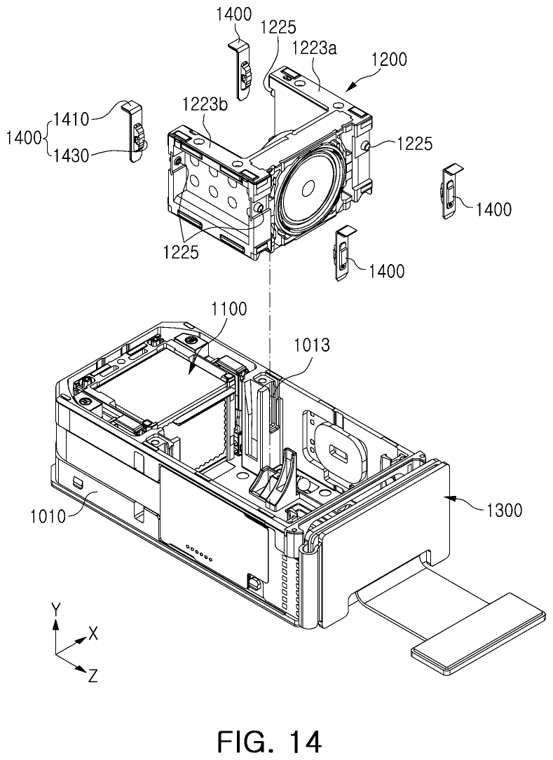

FIG. 14 illustrates an exploded perspective view of an example lens holder and an example stopper according to a third example embodiment.

Referring to FIG. 14, the first support portion (1223a) and the second support portion (1223b) of the lens holder (1220) may each be provided with a plurality of dampers (1225) that are spaced apart from each other in the second optical axis direction (Z-axis direction). For example, the plurality of dampers (1225) may be formed integrally with the lens holder (1220) through an insert injection-molded process.

According to the present embodiment, the stopper (1400) and the damper (1225) may correspond on a one-to-one basis. That is, the plurality of stoppers (1400) may face the damper (1225) provided on the first support portion (1223a) or the second support portion (1223b) opposing thereto, respectively.

The plurality of dampers (1225) may be opposed to the buffer member (1430) of the stopper (1400). They may be formed to protrude toward each other. Preferably, the plurality of dampers (1225) may be provided to face the maximum protruding surface (or projection) (1431) of the buffer member (1430).

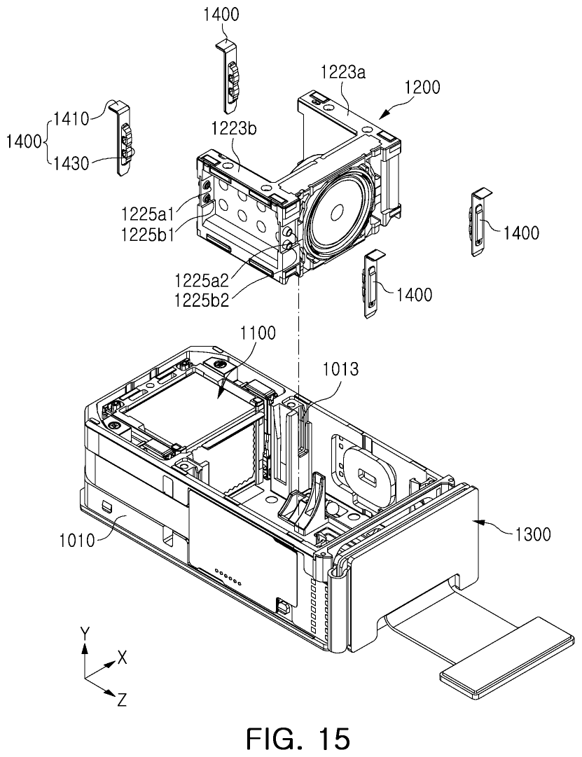

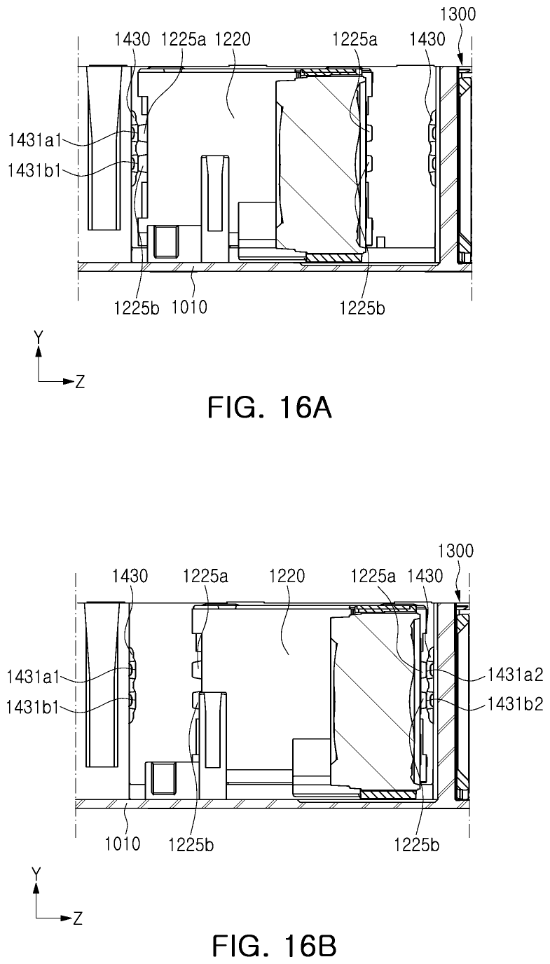

FIG. 15 illustrates an exploded perspective view of an example lens holder and a stopper in accordance with a fourth embodiment, and FIGS. 16A and 16B are side views illustrating an example lens holder in accordance with a fourth embodiment in contact with a stopper while being moved to the maximum position.

Referring to FIG. 15, a first pair of dampers (1225a1, 1225b1) disposed in the first optical axis direction (Y-axis direction) may be spaced apart from a second pair of dampers (1225a2, 1225b2) disposed in the second optical axis direction (Z-axis direction) on the second support portion (1223b) (or the first support portion (1223a)) of the lens holder (1220).

According to the present embodiment, the first pair of dampers (1225a1, 1225b1) disposed in the first optical axis direction (Y-axis direction) may be provided on a first surface of the second support portion (1223b) (or the first support portion (1223a)) of the lens holder (1220), and the second pair of dampers (1225a2, 1225b2) disposed in the first optical axis direction (Y-axis direction) may be provided on the second surface of the second support portion (1223b) (or the first support portion (1223a)) facing the stopper (1400) in the second optical axis direction (Z-axis direction), respectively. The first and second pair of dampers (1225a1, 1225b1, 1225a2, 1225b2) may be provided along the longitudinal direction of the buffer member (1430). The first and second pair of dampers (1225a1, 1225b1, 1225a2, 1225b2) may be formed integrally with the lens holder (1220) through an insert injection-molded process.

Additionally, according to the present embodiment, the buffer member (1430) of the stopper (1400) may include a plurality of maximum protrusion surfaces (or projections) (1431a1, 1431b1, 1431a2, 1431b2) formed in the first optical axis direction (Y-axis direction) so as to face the respective pairs of dampers (1225a1, 1225b1, 1225a2, 1225b2), respectively.

Referring to FIGS. 16A and 16B, when the lens holder (1220) is moved to the maximum position toward the folded module (1100) along the second optical axis direction (movement in the −Z-axis direction) and when the lens holder (1220) is moved to the maximum toward the image sensor module (1300) along the second optical axis direction (movement in the +Z-axis direction), the respective pairs of dampers (1225a1, 1225b1, 1225a2, 1225b2) may each come into contact with a plurality of maximum protrusion surfaces (or projections) (1431a1, 1431b1, 1431a2, 1431b2) that respectively opposes them.

Although not illustrated in the drawing, the respective pairs of dampers (1225a1, 1225b1, 1225a2, 1225b2) may be provided on each of the first support portion (1223a) and the second support portion (1223b).

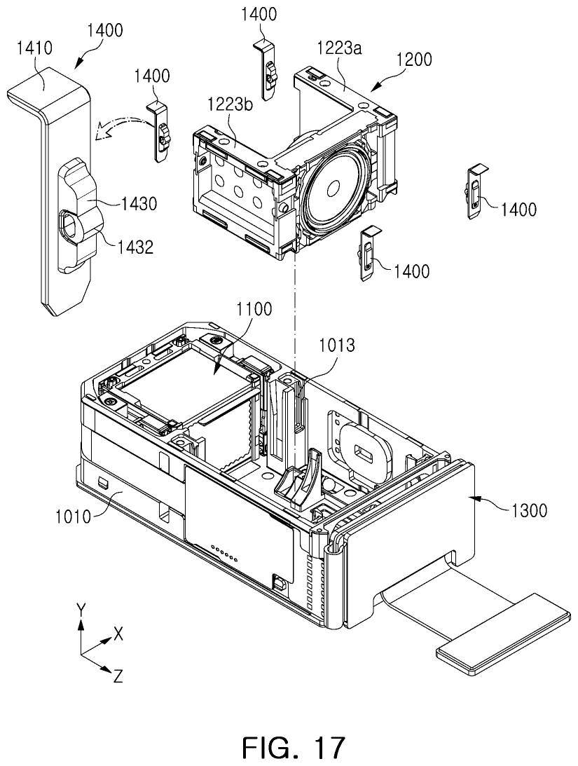

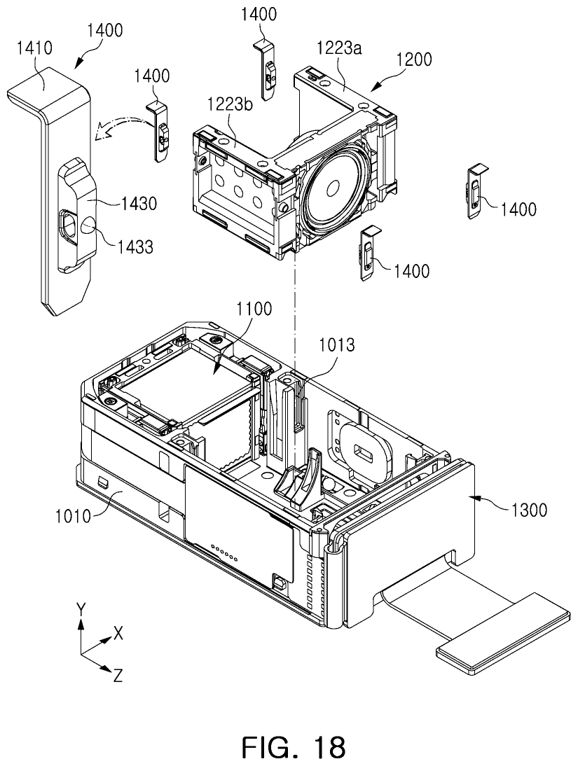

FIG. 17 illustrates an exploded perspective view of an example lens holder and an example stopper in accordance with a fifth embodiment, and FIG. 18 illustrates an exploded perspective view of an example lens holder and an example stopper in accordance with a sixth embodiment.

According to the present example embodiments, the buffer member (1430) of the stopper (1400) that comes into contact with the plurality of dampers (1225) disposed in the lens holder (1220) may be provided in a shape other than a protruding surface.

Referring to FIG. 17, the maximum protrusion (or projection) (1432) of the buffer member (1430) facing the plurality of dampers (1225) may be in the form of a line having a length in the width direction of the buffer member (1430). According to the present embodiment, when the lens holder (1220) is moved to the maximum position in the second optical axis direction (movement in the ±Z-axis direction), the plurality of dampers (1225) may come into contact with the maximum protrusion (1432) of the buffer member (1430), and the contact between the plurality of dampers (1225) and the maximum protrusion (1432) may be a line-contact.

Also, referring to FIG. 18, in an example, the maximum protrusion (or projection) (1433) of the buffer member (1430) that faces the plurality of dampers (1225) may be a hemispherical shape. According to the present embodiment, when the lens holder (1220) is moved to the maximum position in the second optical axis direction (movement in the ±Z-axis direction), the plurality of dampers (1225) may come into contact with the maximum protrusion (1433) of the buffer member (1430), and the contact between the plurality of dampers (1225) and the maximum protrusion (1433) may be a point-contact.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A camera module, comprising:
a housing which has an internal space;
a lens module accommodated in the internal space, and at least a portion of the lens module is configured to move in an optical axis direction; and
a first stopper and a second stopper spaced apart in the optical axis direction in the housing, and each of the first stopper and the second stopper comprises a buffer member that protrudes toward the lens module;
wherein a plurality of dampers, that are spaced apart in the optical axis direction and protrude toward the first stopper and the second stopper, are provided on at least one side of the lens module, and
wherein the plurality of dampers and the buffer member are disposed opposite to each other in the optical axis direction.

2. The camera module of claim 1, wherein the buffer member and the plurality of dampers are formed of an elastic material.

3. The camera module of claim 1, wherein the lens module comprises:
a lens barrel comprising at least one lens, and fixedly disposed in the housing; and
a lens holder comprising at least one lens, and configured to move in the optical axis direction in the housing;
wherein the plurality of dampers are provided on the lens holder.

4. The camera module of claim 3, wherein the lens holder comprises:
a lens mounting portion that is spaced apart from the lens barrel in the optical axis direction, and on which the at least one lens is mounted; and
a first support portion and a second support portion that extend in the optical axis direction from a first side of the lens mounting portion and a second side of the lens mounting portion toward the lens barrel, respectively;
wherein the plurality of dampers are provided on at least one of the first support portion and the second support portion.

5. The camera module of claim 3, wherein the plurality of dampers are formed integrally with the lens holder.

6. The camera module of claim 3, further comprising:
a damper holder coupled to at least one side surface of the lens holder,
wherein the plurality of dampers are provided on the lens holder via the damper holder.

7. The camera module of claim 1, wherein the plurality of dampers comprise a pair of dampers that are disposed in a direction perpendicular to the optical axis direction, and
wherein the buffer member comprises a pair of protrusions that face the pair of dampers in the optical axis direction.

8. The camera module of claim 3, wherein the lens module comprises:
a lens module driving portion comprising a driving magnet and a driving coil, and configured to provide a driving force to move the lens holder in the optical axis direction,
wherein the driving magnet is disposed on a first side surface of the lens holder, and
wherein the plurality of dampers are disposed on a second side surface of the lens holder opposite to the first side surface of the lens holder at least with respect to an optical axis.

9. The camera module of claim 1, further comprising:
a folded module including a reflective member, and the folded module is disposed in front of the lens module based on a path of light;
an image sensor module comprising an image sensor, and disposed at a rear portion of the lens module based on the path of light;
wherein the first stopper and the second stopper are disposed between the folded module and the lens module, and are further disposed between the lens module and the image sensor module.

10. A camera module, comprising:
a folded module disposed in a housing, and configured to change a path of light;
a lens module comprising one or more lenses on which light passing through the folded module is incident;
an image sensor module into which light passing through the lens module is incident; and
a first stopper and a second stopper spaced apart in an optical axis direction with the lens module interposed therebetween;
wherein a buffer member is provided on the first stopper and the second stopper, respectively, to protrude toward the lens module, and
a plurality of dampers are provided on the lens module, to protrude toward the first stopper and the second stopper respectively, and face the buffer member in the optical axis direction.

11. The camera module of claim 10, wherein the lens module comprises:
a lens barrel fixedly disposed in the housing; and
a lens holder disposed in the housing, and configured to move in the optical axis direction between the folded module and the image sensor module,
wherein the plurality of dampers are provided on the lens holder.

12. The camera module of claim 11, wherein the plurality of dampers are formed integrally with the lens holder.

13. The camera module of claim 11, wherein the plurality of dampers are spaced apart from each other in the optical axis direction on at least one side surface of the lens holder.

14. The camera module of claim 11, further comprising:
a damper holder coupled to at least one side surface of the lens holder;
wherein the plurality of dampers are provided on the lens holder via the damper holder.

15. The camera module of claim 11, wherein the plurality of dampers comprise a pair of dampers that are disposed in a direction perpendicular to the optical axis direction,
wherein the buffer member comprises a pair of protrusions that face the pair of dampers in the optical axis direction.

16. The camera module of claim 10, wherein the buffer member and the plurality of dampers are formed of an elastic material.

17. A camera module, comprising:
a housing comprising an internal space;
a lens holder disposed in the internal space and configured to move in an optical axis direction; and
a first stopper disposed in the housing, and the first stopper comprises a buffer member that protrudes toward the lens module;
wherein a damper, that protrudes toward the first stopper, is disposed on at least one side of the lens holder, and
wherein the damper and the buffer member are disposed opposite to each other in the optical axis direction.

18. The camera module of claim 17, further comprising a second stopper spaced apart from the first stopper in the optical axis direction.
